(19) United States
(12) Patent Application Publication
(10) Pub. No.: US 2012/0049576 A1
(43) Pub. Date: Mar. 1, 2012

(54) Motor Vehicle Glass

(75) Inventors: Alfred Ott, Gaeufelden (DE); Juergen Schrader, Weil im Schoenbuch (DE); Uwe Siehler, Gaeufelden (DE)

(73) Assignee: Daimler AG, Stuttgart (DE)

(21) Appl. No.: 13/263,210

(22) PCT Filed: Mar. 27, 2010
(86) PCT No.: PCT/EP2010/001962

§ 371 Date: Nov. 9, 2011

(30) Foreign Application Priority Data
Apr. 7, 2009 (DE) 1020090166866

(51) Int. Cl. B60J 1/08

(52) U.S. Cl. 296/200

(57) ABSTRACT

A side window glass of a motor vehicle includes an electrical functional element arranged in or on the glass and a control unit for actuating the electrical functional element. A holding device for the control unit is arranged on an edge of the glass.

### BACKGROUND AND SUMMARY OF THE INVENTION

The invention relates to glass, in particular a side window glass, of a motor vehicle, having an electrical functional element arranged in and/or on the glass and a control unit for actuating the electrical functional element.

Such glass is generally known from prior art. The electrical functional elements referred to above may, for example, be window heaters or devices for controlling the optical transmission of the glass. The control unit for the electrical functional elements is generally supplied by the usual 12 V electrical system of the vehicle. As the functional elements themselves often require a higher voltage, the voltage is converted in the control unit and transmitted to the electrical functional elements via a high-voltage connection. The control unit is usually separate from the glass, so that the high-voltage part of the electric interconnection has to be routed via separate cable connections. This is particularly disadvantageous for side windows, which have to be movable, because the cables of the high-voltage circuit have to be moved as well and are therefore subject to high wear. Glass of this type is, for example, disclosed in European Patent Publication No. EP 1 256 261 B1.

Exemplary embodiments of the present invention are directed to a glass of the type referred to above arranged in such a way that the connection between the electrical functional element and the control unit is improved and wear is reduced.

According to the exemplary embodiments of the present invention, it is a holding device for the control unit is provided at an edge of the glass. Therefore, there is no longer any spatial distance between the control unit and the electrical functional element. In the case of movable side windows, in particular, the control unit now moves together with the electrical functional element, so that a connection between the functional element and the control unit can no longer be affected by movement. As a result, the wear of the connection is reduced and the durability of the glass as a whole is improved considerably. In movable side windows, the holding device for the control unit is preferably provided at a lower edge of the glass, so that the holding device can be fitted before the side window glass is installed. By mounting the holding device at the lower edge of the glass, space problems are avoided when inserting the glass through the window well.

The holding device preferably comprises a latching connecting element for locking the control unit in position. Owing to the reversibly releasable latching connection, damaged control units can be replaced in a very simple way without having to replace the whole of the glass.

The holding device further preferably comprises an electrical contact device for connecting the control unit to the electrical functional element. The functions of the mechanical holder of the control unit and of the electrical connection between the control unit and the electrical functional element are therefore advantageously integrated within one component, so that there is no need for further components and savings can be made in terms of weight. This is again particularly important in movable side windows, which, being movable, have to be as light as possible.

The at least one electrical contact element is preferably designed for connecting a high-voltage output of the control unit to a high-voltage input of the electrical functional element. As a result, high-voltage connections between the control unit and the electrical functional element can be avoided, so that the high-voltage circuit is kept as short as possible. This further reduces the risk of damage to or wear of the high-voltage circuit.

The electrical contact element may be designed as a cable connection. In a particularly preferred embodiment, however, the electrical contact element is designed as a latching connection between a contact surface assigned to the control unit and a contact surface assigned to the holding device. The high-voltage circuit does therefore not require any cable connections at all, keeping the risk of damage to a minimum. Therefore, the high-voltage circuit between the electrical functional element and the control unit is completely self-contained, and the control unit only has to be externally connected to the electrical system via a 12 V line.

As a whole, the invention creates an easily installable, cost-effective and self-contained high-voltage system for electrical functional elements of glass, which can be used individually and does not require any high-voltage or AC lines at all.

### BRIEF DESCRIPTION OF THE DRAWING FIGURES

The invention and its embodiments are explained in greater detail below with reference to the drawings. Of the drawings:

FIG. 1 is a diagrammatic representation of an embodiment of glass according to the invention; and

FIG. 2 is a detailed view of a holding device with a control unit secured therein according to the embodiment from FIG. 1.

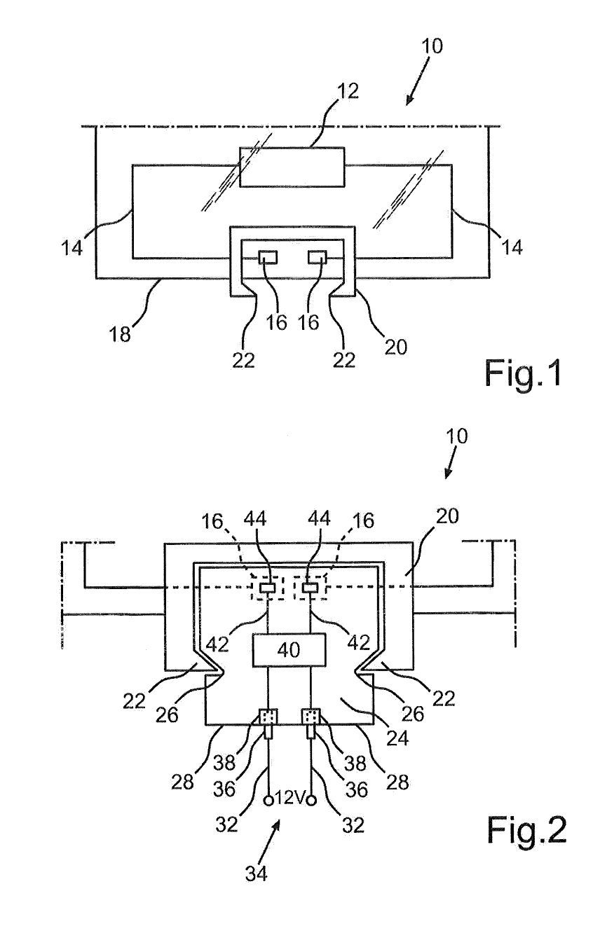

### DETAILED DESCRIPTION

A glass identified as a whole by the reference number 10, in particular a side window glass for a motor vehicle, comprises an electrical functional element 12. The electrical functional element 12 may be, for example, an electric resistance heater vapor-deposited on the glass 10 or a device for controlling the transmission of the glass 10. The electrical functional element 12 as a rule requires a high-voltage supply, which is provided via lines 14 which are likewise vapor-deposited on the glass. The lines 14 terminate in contact plates 16 in the region of the lower edge 18 of the glass 10.

In order to keep a high-voltage connection situated outside the glass 10 as short as possible, a holding device 20 capable of accommodating a control unit for the electrical functional element 12 is provided at the lower edge 18 of the glass in the region of the contact plates 16. The holding device 20 is preferably made of plastic and bonded to the lower edge 18 of the glass, at least partially encompassing the glass 10. To keep the connection to the control unit as simple as possible, the holding device comprises two latching elements 22 by means of which the control unit can be reversibly secured to the holding device 20.

The mounting of a control unit 24 in the holding device 20 is shown in detail in FIG. 2. The latching elements 22 engage grooves 26 of the housing 28 of the control unit 24 and hold the latter against the glass 10. The control unit 24 does not require any high-voltage supply. On the contrary, it is connected to the electrical system 34 of a motor vehicle via lines 30, 32 and therefore supplied with 12 V DC in the usual manner. The connection is established via plugs 36 which are inserted into corresponding sockets 38 of the control unit 24.

The 12 V DC supplied by the electrical system 34 are converted in a voltage transformer 40 of the control unit 24 in accordance with externally supplied control commands to deliver the high voltage required for the operation of the electrical functional element 12. Via further lines 42 and contact plates 44 on the control unit 24, the high voltage is made available to the electrical functional element 12. As the control unit 24 latches into the holding device 20, the contact plates 44 come to cover the contact plates 16 of the glass 10 and are pressed against the latter, so that the lines 42 of the control unit are in electrically conductive contact with the lines 14 of the glass 10.

The glass 10 does therefore not require any movable high-voltage or AC lines, so that any damage to the high-voltage system is eliminated virtually completely even if the glass 10 moves. At the same time, the reversible mounting of the control unit 24 in the holding device 20 by means of the latching elements 22 allows an easy replacement of the control unit 24 in case of damage or a hardware upgrade.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-6. (canceled)

7. An apparatus, comprising:
a motor vehicle side window glass;
an electrical functional element arranged in or on the motor vehicle side window glass;
a control unit configured to actuate the electrical functional element; and
a holding device arranged at an edge of the motor vehicle side window glass, the holding device configured to hold the control unit.

8. The apparatus of claim 7, wherein the holding device comprises at least one latching connecting element configured to lock the control unit in position.

9. The apparatus as claimed in claim 7, wherein the holding device comprises at least one electrical contact element configured to connect the control unit to the electrical functional element.

10. The apparatus as claimed in claim 8, wherein the holding device comprises at least one electrical contact element configured to connect the control unit to the electrical functional element.

11. The apparatus according to claim 9, wherein the at least one electrical contact element is configured to connect a high-voltage output of the control unit to a high-voltage input of the electrical functional element.

12. The apparatus according to claim 10, wherein the at least one electrical contact element is configured to connect a high-voltage output of the control unit to a high-voltage input of the electrical functional element.

13. The apparatus according to claim 9, wherein the electrical contact element is a cable connection.

14. The apparatus according to claim 10, wherein the electrical contact element is a cable connection.

15. The apparatus of claim 9, wherein the electrical contact element is configured as a latching connection between a contact surface of the control unit and a contact surface of the holding device or of the glass.

16. The apparatus of claim 10, wherein the electrical contact element is configured as a latching connection between a contact surface of the control unit and a contact surface of the holding device or of the glass.
